(19) United States
(12) Patent Application Publication
(10) Pub. No.: US 2005/0108290 A1
(43) Pub. Date: May 19, 2005

(54) Logic computing system and method

(76) Inventors: Takashi Mita, Kanagawa (JP); Akinori Nishihara, Kanagawa (JP)

Correspondence Address: Mitchell P Brook;Luce forward halmilton & Scripps, Suite 200, 11988 El Camino Real, San Diego, CA, 92130, US

(21) Appl. No.: 10/500,197

(22) PCT Filed: Dec. 24, 2002
(86) PCT No.: PCT/JP02/13442

(30) Foreign Application Priority Data
Dec. 28, 2001 (JP) 2001-401462

(51) Int. Cl. G06F 12/00

(52) U.S. Cl. 707/200

(57) ABSTRACT

A FPGA data module to be referred to as a LUT by a logic block (43) is divided into a plurality of modules. Each of a plurality of data registers (41a to 41d) stores one of the plurality of FPGA data modules. By referring to the FPGA data module(s) stored in one or more of the plurality of data registers (41a to 41d), a gate circuit (43a) and flip flop (43b) of the logic block (43) generates a logical function value of logic input data. The logical function value of the logic input data is provided as logic output data.

### TECHNICAL FIELD

The present invention relates to direct execution of a program by hardware, and particularly relates to a computing system suitable for executing a large-sized program.

### BACKGROUND ART

When a contemporary general-purpose computer executes an operation process, the CPU (Central Processing Unit) sequentially interprets a plurality of operation codes corresponding to a program. The plurality of operation codes are stored in a memory to form software. Thus, the program is realized by the software. The structure of the CPU as hardware is not optimized for individual operation processes included in the software program. Therefore, large overhead is incurred during operations processes executed by the CPU.

In the meantime, PCT WO 94/10627 Publication (Japanese National Publication No. H8-504285) and PCT WO 98/08306 Publication (Japanese National Publication No. 2000-516418) disclose systems employing a FPGA (Field Programmable Gate Array), as techniques for executing a program by hardware. Unexamined Japanese Patent Application KOKAI Publication No. H8-330945 discloses dynamic reprogramming in a programmable array.

In a FPGA, a logical function realized by a plurality of logic circuits is changed in accordance with configuration data which is externally supplied as a program. In other words, a result of an operation process via the FPGA depends on the hardware structure of the FPGA corresponding to the configuration data.

Processing speed of a FPGA is not as high as that of an ASIC (Application Specific Integrated Circuit) intended only for executing a specific operation process. However, a FPGA can execute an operation process at much higher speed than a CPU of a conventional general-purpose computer.

A program to be executed by a current general-purpose computer is divided into a plurality of modules. Especially, a large-sized program contains many modules. For example, a first program module being executed by a CPU calls a second program module. After the second program module is processed, a third program module is called, or the first program module is called back. Such a link between a plurality of program modules realizes an operation process corresponding to a program as a whole. Each program module can be designed independently from other program modules. In addition, each program module can be reused as a part of another software in some cases. Such usage of program modules can reduce time required for designing the entire program.

In a conventional computing system employing a FPGA, there are some cases where the hardware is divided into a plurality of modules corresponding to some functions. In such cases, the plurality of hardware modules are connected to each other via a connection line such as a bus. However, there has not been proposed a system where data for changing the logical function of the FPGA is divided into a plurality of modules. In the conventional FPGA, configuration data for each of the plurality of gate arrays is rewritten one by one. While the configuration data is rewritten, logic computing is halted. In accordance with this method, it takes a long time to update the configuration data. Updating of the configuration data in the conventional FPGA incurs large overhead and thus lowers the processing capacity of the entire system. Accordingly, it has been difficult to frequently change the logical function in a computing system employing a conventional FPGA. The inflexibility of the logical function restricts the scale of a program which is executable by a system.

### DISCLOSURE OF INVENTION

The object of the present invention is to provide a logic computing system for executing a large-sized program including a plurality of modules efficiently by hardware, without using a general-purpose CPU.

To accomplish the above object, a logic computing system according to the present invention comprises:

a plurality of data storage units (41a to 41d, 49a to 49d) which store a plurality of configuration data modules each of which includes a look up table; and

a logic computing unit (43) which includes a plurality of programmable logic circuits (43a),

wherein the logic computing unit (43) provides a logical function value of logic input data as logic output data, by referring to at least one configuration data module stored in at least one of the plurality of data storage units (41a to 41d, 49a to 49d).

According to this structure, overhead is hardly incurred due to updating configuration data. Accordingly, logic computing in accordance with a large-sized program is efficiently executed, and executing speed of the program becomes higher.

The plurality of data storage units (41a to 41d) may form a shift register (40).

The logic computing unit (43) may refer to the configuration data module(s) stored in one or more of the plurality of data storage units (41a to 41d) included in the shift register (40).

The shift register (40) may shift the configuration data modules among the plurality of data storage units (41a to 41d) circularly.

The logic computing system may comprise a selector (42) which selects at least one of the plurality of data storage units (49a to 49d).

The logic computing unit (43) may refer to the configuration data module which is stored in the data storage unit selected by the selector (42).

The selector (42) may select one of the plurality of data storage units from among the plurality of data storage units (49a to 49d) circularly.

The logic computing system may comprise:

a parameter register (45) which stores all or part of internal parameters of the logic computing unit (43) for stacking;

a detector (44) which detects a call and a call back by one of the plurality of configuration data modules to another one of the plurality of configuration data modules; and

a controller (47) which controls logic computing by the logic computing unit,

wherein the controller (47) may:

store the internal parameters of the logic computing unit in the parameter register (45), when the detector (44) detects a call by one of the plurality of configuration data modules to another one of the plurality of configuration data modules as a subroutine; and

restore the internal parameters stored in the parameter register (45) in the logic computing unit (43), when the detector (44) detects a call back to one of the plurality of configuration data modules.

According to this structure, it is possible to store internal parameters of the logic computing unit in the parameter register, when configuration data modules are changed. The internal parameters stored in the parameter register are restored when there occurs a call back of configuration data. In this way, a large-sized program including a plurality of modules can be executed at high speed by hardware.

The logic computing system may further comprise a loader (3) which loads the configuration data module(s) to one or more of the plurality of data storage units (41a to 41d, 49a to 49d).

Each of the plurality of data storage units (41a to 41d, 49a to 49d) may store the configuration data module rewritably.

The loader can load the configuration data modules to the plurality of data storage units from outside. Due to this structure, a large-sized program comprising many data modules can be executed by hardware.

The logic computing system may comprise:

a detector (44) which detects a call by one of the plurality of configuration data modules to another one of the plurality of configuration data modules; and

a controller (47) which controls logic computing by the logic computing unit (43),

wherein

the controller (47):

may search, when the detector detects a call by one of the plurality of configuration data modules to another one of the plurality of configuration data modules as a subroutine, the plurality of data storage units (41a to 41d, 49a to 49d) for the configuration data module as the subroutine; and

may send a load command to the loader (3), in a case where the configuration data module as the subroutine is not searched out, and

the loader (3) may load the configuration data module as the subroutine which is indicated by the load command to one of the plurality of data storage units (41a to 41d, 49a to 49d).

The logic computing system may comprise:

a parameter buffer (46) which stores all or part of internal parameters of the logic computing unit (43) for handing;

a detector (44) which detects a call or a call back by one of the plurality of configuration data modules to another one of the plurality of configuration data modules; and

a controller (47) which controls logic computing by the logic computing unit,

wherein the controller (47):

may store the internal parameters of the logic computing unit (43) in the parameter buffer (46), when the detector (44) detects a call or a call back by one of the plurality of configuration data modules to another one of the plurality of configuration data modules; and

may input the parameters stored in the parameter buffer (46) to the logic computing unit (43), when the configuration data module which is called or called back is arranged so that it can be referred to by the logic computing unit (43).

According to this structure, the logic computing system can hand parameters over between a plurality of modules.

The logic computing system may comprise a compiler (6) which creates each of the plurality of configuration data modules based on each of a plurality of source program modules.

To accomplish the above object, a logic computing method according to the present invention comprises:

storing a plurality of configuration data modules each of which includes a look up table in a plurality of data storage units (41a to 41d, 49a to 49d);

preparing a logic computing unit (43) which includes a plurality of programmable logic circuits (43a);

referring by the logic computing unit (43) to at least one configuration data module stored in at least one of the plurality of data storage units (41a to 41d, 49a to 49d); and

providing a logical function value of logic input data as logic output data, based on the configuration data module referred to by the logic computing unit (43).

The logic computing method may comprise:

forming a shift register (40) using the plurality of data storage units (41a to 41d); and

referring to the configuration data module(s) stored in at least one or more of the plurality of data storage units (41a to 41d) included in the shift register (40).

The logic computing method may comprise

shifting by the shift register (40) the configuration data modules among the plurality of data storage units (41a to 41d) circularly.

The logic computing method may comprise:

selecting by a selector (42) at least one of the plurality of data storage units (49a to 49d); and

referring to the configuration data module stored in the data storage unit selected by the selector (42).

Selection made by the selector (42) may be changed among the plurality of data storage units (49a to 49d) circularly.

The logic computing method may comprise:

detecting a call by one of the plurality of configuration data modules to another one of the plurality of configuration data modules as a subroutine;

storing all or part of internal parameters of the logic computing unit (43) in a parameter register (45) in response to the detecting; and

restoring the internal parameters stored in the parameter register (45) in the logic computing unit (43), when one of the plurality of configuration data modules is called back.

The logic computing method may comprise:

storing the plurality of configuration data modules in the plurality of data storage units (41a to 41d, 49a to 49d) rewritably; and

loading by a loader (3) at least one of the plurality of configuration data modules to be stored in the plurality of data storage units (41a to 41d, 49a to 49d).

The logic computing method may comprise:

searching, when a call by one of the plurality of configuration data modules to another one of the plurality of configuration data modules as a subroutine is detected, the plurality of data storage units (41a to 41d, 49a to 49d) for the configuration data module as the subroutine;

sending a load command to the loader (3), in a case where the configuration data module as the subroutine is not searched out; and

loading by the loader (3) the configuration data module as the subroutine which is indicated by the load command to one of the plurality of data storage units (41a to 41d, 49a to 49d).

The logic computing method may comprise:

detecting a call or a call back by one of the plurality of configuration data modules to another one of the plurality of configuration data modules;

storing all or part of internal parameters of the logic computing unit (43) in a parameter buffer (46) in response to the detecting; and

inputting the parameters stored in the parameter buffer (46) to the logic computing unit (43), when the configuration data module which is called or called back is arranged so that it can be referred to by the logic computing unit (43).

The logic computing method may comprise

creating by a compiler (6) each of the plurality of configuration data modules based on each of a plurality of source program modules.

### BRIEF DESCRIPTION OF DRAWINGS

These objects and other objects and advantages of the present invention will become more apparent upon reading of the following detailed description and the accompanying drawings in which:

FIG. 1 shows a structure of a computing system according to a first embodiment;

FIG. 2 shows one modified structure of the computing system according to the first embodiment;

FIG. 3 shows one modified structure of the computing system according to the first embodiment;

FIG. 4 shows one modified structure of the computing system according to the first embodiment;

FIG. 5 shows one modified structure of the computing system according to the first embodiment;

FIG. 6 shows a structure of a computing system according to a second embodiment; and

FIG. 7 shows one modified structure of the computing system according to the second embodiment.

### BEST MODE FOR CARRYING OUT THE INVENTION

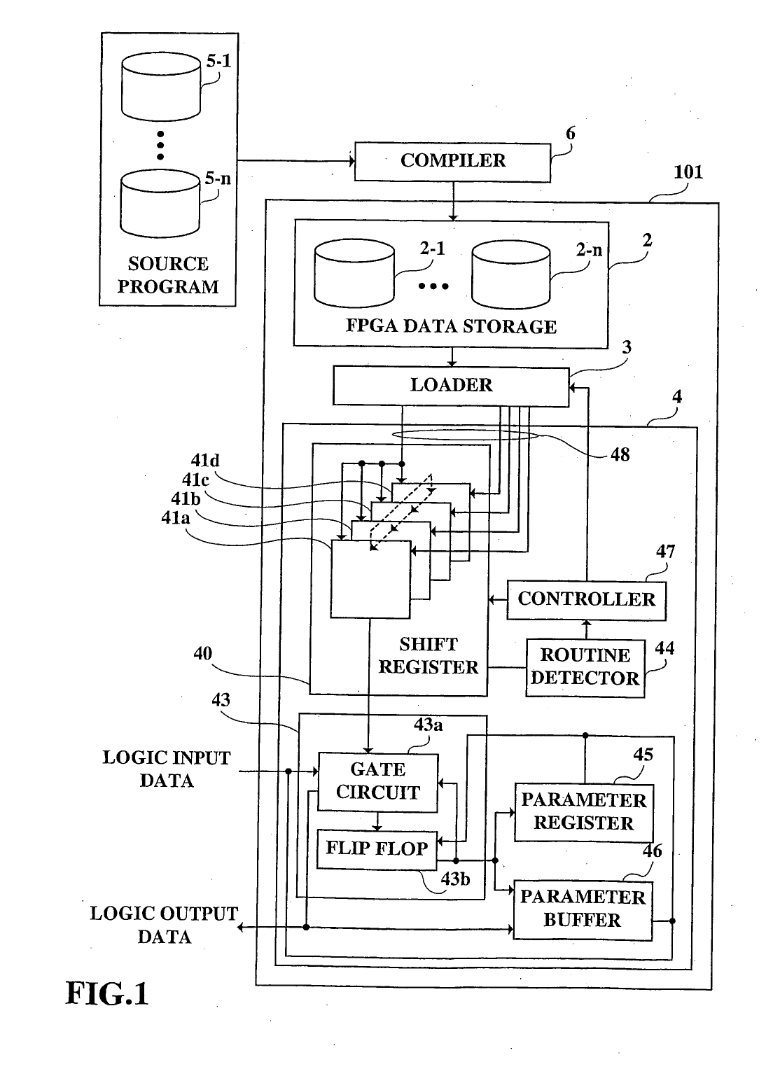

FIG. 1 shows a structure of a computing system 101 according to a first embodiment of the present invention. The computing system 101 shown in FIG. 1 is a programmable logic unit. The computing system 101 comprises a FPGA data storage 2, a loader 3, and a FPGA device 4.

The FPGA data storage 2 stores all of a plurality of FPGA data modules 2-1 to 2-n. A compiler 6 arranged outside of the computing system 101 compiles a plurality of source programs 5-1 to 5-n in order to create the FPGA data modules 2-1 to 2-n. The compiler 6 may be included in the computing system 101. The source programs 5-1 to 5-n are programmed by a hardware description language. For example, the FPGA data module 2-1 is created by compiling the source program 5-1. The FPGA data module 2-2 is created by compiling the source program 5-2, and the same goes for the rest of the FPGA data modules. Each of the FPGA data modules 2-1 to 2-n is a configuration data module including data for forming a look up table (LUT). Correspondence between logic input data and logic output data in the FPGA device 4 is shown by the LUT. At least one module of the source programs 5-1 to 5-n calls another module among the source programs 5-1 to 5-n. In accordance with this relationship between the source programs 5-1 to 5-n, at least one module of the FPGA data modules 2-1 to 2-n has relevance to another module among the FPGA data modules 2-1 to 2-n. For an example, one of the FPGA data modules 2-1 to 2-n serves as a subroutine of another module among the FPGA data module 2-1 to 2-n. For another example, the FPGA data modules 2-1 to 2-n correspond to a series of program modules to be processed one after another, respectively.

The loader 3 loads the FPGA data modules 2-1 to 2-n from the FPGA data storage 2 onto the FPGA device 4 in response to a plurality of load commands. One of the plurality of load commands is supplied from outside of the FPGA device 4, when the FPGA device 4 starts up. The other load commands are generated in the process of computing by the FPGA device 4. The loader 3 loads one of the FPGA data modules 2-1 to 2-n from the FPGA data storage 2 onto one of data registers 41a to 41d in response to one load command. For example, the loader 3 is connected to the data registers 41a to 41d via a bus 48. The bus 48 includes a data bus, an address bus, a write enable line, and the like. In response to a load command, the loader 3 transmits an address signal to the address bus of the bus 48, and turns a signal on the write enable line into an active level. After the signal on the write enable line is turned into an active level, the loader 3 transmits a data signal to the data bus of the bus 48.

The FPGA device 4 forms a logic circuit by referring to one or a plurality of module(s) loaded by the loader 3 among the FPGA data modules 2-1 to 2-n. The FPGA device 4 generates a logical function value of logic input data which is input from outside of the computing system 101. For example, the logic input data of the FPGA device 4 may be supplied by means of an input unit such as a keyboard. Or, the logic input data may be read out from an external storage such as a hard disk drive (HDD). The logical function value of the logic input data is provided to outside as logic output data of the computing system 101. For example, the logic output data of the FPGA device 4 may be provided to an output unit such as a display device. Or, the logic output data may be written onto an external storage. Further, the logic output data may be used for controlling peripheral devices.

The FPGA device 4 comprises a shift register 40, a logic block 43, a routine detector 44, a parameter register 45, a parameter buffer 46, and a controller 47.

The shift register 40 shown in FIG. 1 includes four data registers 41a to 41d. For example, each of the data registers 41a to 41d includes a plurality of flip flops in accordance with sizes of the FPGA data modules 2-1 to 2-n. Each of the data registers 41a to 41d stores one of the FPGA data modules 2-1 to 2-n loaded by the loader 3 from the FPGA data storage 2. For example, in a case where the signal on the write enable line of the bus 48 is active, data corresponding to a signal on the data bus of the bus 48 is written into an address corresponding to a signal on the address bus of the bus 48, in one of the data registers 41a to 41d selected by the loader 3.

Data modules stored in the data registers 41a to 41d can be shifted among the data registers 41a to 41d circularly. Circulation of data modules inside the shift register 40 is shown by a broken line in FIG. 1. In more detail, a data module stored in the data register 41d is shifted to the data register 41c. A data module stored in the data register 41c is shifted to the data register 41b. A data module stored in the data register 41b is shifted to the data register 41a. A data module stored in the data register 41a is shifted to the data register 41d. In the shift register 40 shown in FIG. 1, the data module stored in the data register 41a is referred to by the logic block 43 as a look up table. The data modules stored in the data registers 41a to 41d respectively are shifted to other data registers in parallel. Therefore, data modules to be referred to by the logic block 43 are changed circularly.

The logic block 43 comprises a gate circuit 43a and a flip flop 43b. The actual logic block 43 may comprise a plurality of gate circuits 43a and flip flops 43b. For exemplary explanation, FIG. 1 shows one gate circuit 43a and one flip flop 43b.

The gate circuit 43a is a programmable logic circuit for realizing plural kinds of logic gates (for example, AND, OR, NOT, XOR, and combinations of those functions). A logical function of the gate circuit 43a is determined based on the data module stored in the data register 41a. The flip flop 43b retains an output from the gate circuit 43a as internal parameters. Further, a parameter can be externally written into the flip flop 43b.

The routine detector 44 identifies a relationship between a data module stored in the data register 41a and another data module. If the data module stored in the data register 41a is related to another data module among the FPGA data modules 2-1 to 2-n, the routine detector 33 specifies the related another data module. The specified data module is reported to the controller 47.

The parameter register 45 stores all or part of parameters stored in the flip flop 43b for stacking, when data modules stored in the shift register 40 are shifted. For example, the parameter register 45 may stack parameters in accordance with LIFO (Last In First Out) method. Parameters stacked in the parameter register 45 are returned to the flip flop 43b when a same data module is shifted again to the data register 41a as called back.

The parameter buffer 46 stores all or part of parameters stored in the flip flop 43b for handing, when a data module stored in the data register 41a calls another data module as a subroutine. When the data module to be referred to as the subroutine in a succeeding process is shifted to the data register 41a, the parameters stored in the parameter buffer 46 are returned to the logic block 43 as an input to the gate circuit 43a. In another situation, when one of the FPGA data modules 2-1 to 2-n is called back as a main routine, the parameter buffer 46 stores an output of the logic block 43 as return values. When the data module to be referred to as the main routine is shifted to the data register 41a, the parameters stored in the parameter buffer 46 are returned to the logic block 43 by being written into the flip flop 43b.

The controller 47 controls logic computing in the logic block 43. When the routine detector 44 detects a call by a data module stored in the data register 41a to another data module, the controller 47 distinguished between parameters to be stacked and parameters to be handed among internal parameters stored in the flip flop 43b. Parameters to be stacked are stored in the parameter register 45. Parameters to be handed are input to the parameter buffer 46. The controller 47 tries to detect another data module specified by the routine detector 44 in the data registers 41b to 41d. If the data module specified by the routine detector 44 is detected, the controller 47 drives the shift register 40 in order to shift this data module to the data register 41a. On the other hand, if the data module specified by the routine detector 44 is not detected in the data registers 41b to 41d, the controller 47 sends a load command to the loader 3. This load command designates one of the FPGA data modules 2-1 to 2-n that is to be loaded, and one of the data registers 41a to 41d whose content is to be rewritten. After loading by the loader 3, the controller 47 drives the shift register 40 in order to shift the leaded data module to the data register 41a. When the intended data module is shifted to the data register 41a, the controller 47 controls parameters stored in the parameter buffer 46 to be written into the flip flop 43b.

When one of the FPGA data modules 2-1 to 2-n is called back as a main routine, the controller 47 specifies parameters to be handed among internal parameters stored in the flip flop 43b. The parameters specified by the controller 47 are input to the parameter buffer 46. When the data module as the main routine is shifted to the data register 41a, the controller 47 controls parameters stored in the parameter register 45 to be written into one part of the flip flop 43b, and controls parameters stored in the parameter buffer 46 to be written into the other part of the flip flop 43b.

According to the computing system 101 of the first embodiment, firstly, the loader 3 receives a load command from outside. The loader 3 loads one of the FPGA data modules 2-1 to 2-n from the FPGA data storage 2 to the data register 41a in accordance with the load command.

For example, the loader 3 loads the FPGA data module 2-1 onto the data register 41a. When loading of the FPGA data module 2-1 is completed, the logic block 43 forms a logic circuit by referring to the data register 41a storing the FPGA data module 2-1. Logic input data supplied to the logic block 43 from outside is introduced into the gate circuit 43a. The gate circuit 43a and the flip flop 43b generate a logical function value of the logic input data by referring to the data register 41a storing the FPGA data module 2-1 as a LUT. The logic block 43 provides the logical function value of the logic input data to outside as logic output data. In this way, the computing system 101 executes an operation corresponding to the FPGA data module 2-1 as a main routine. In such logic computing by the FPGA device 4, the routine detector 44 detects a call by the data module stored in the data register 41a to another data module.

For one example, the FPGA data module 2-1 is related to the FPGA data module 2-n. In this case, the routine detector 44 detects a call by the FPGA data module 2-1 to the FPGA data module 2-n. In response to the detection by the routine detector 44 of the call, the controller 47 stores internal parameters stored in the flip flop 43b in the parameter register 45 and/or the parameter buffer 46. In addition, the controller 47 stores a main routine identifier for the FPGA data module 2-1 in the parameter register 45 in association with the internal parameters.

The controller 47 searches the data registers 41a to 41d for the FPGA data module 2-n as the subroutine. If the FPGA data module 2-n is not found, the controller 47 sends a load command to the loader 3. In this example, the FPGA data module 2-n is loaded from the FPGA data storage 2 to the data register 41b in accordance with this load command. When loading of the FPGA data module 2-n is completed, the controller 47 drives the shift register 40 in order to shift the FPGA data module 2-n to the data register 41a. All register elements included in the data register 41b transfer the FPGA data module 2-n to the register elements of the data register 41a in parallel. At the same time, the FPGA data module 2-1 stored in the data register 41a is shifted to the data register 41d.

If the FPGA data module 2-n is found in any of the data registers 41a to 41d, the controller 47 drives the shift register 49 without performing loading of any data module. In accordance with the driving of the shift register 40, the FPGA data module 2-n is shifted to the data register 41a.

When shifting of the data modules is completed, the logic block 43 reconfigures the logic circuit by referring to the data register 41a which stores the FPGA data module 2-n. At this time, parameters stored in the parameter buffer 46 are returned to the logic block 43 as all or a part of an input to the gate circuit 43a.

When reconfiguration of the logic circuit is completed, the gate circuit 43a and the flip flop 43b can generate a logical function value of the logic input data by referring to the data register 41a storing the FPGA data module 2-n as a LUT. Thereby, the computing system 101 executes an operation corresponding to the FPGA data module 2-n as the subroutine.

When the operation corresponding to the FPGA data module 2-n is completed, the FPGA data module 2-1 as the main routine is called back. In order to call back the FPGA data module 2-1, the controller 47 stores the logic output data of the logic block 43 in the parameter buffer 46. The controller 47 obtains the main routine identifier stored in the parameter register 45. This main routine identifier indicates the FPGA data module 2-1 as the main routine. Based on this main routine identifier, the controller 47 drives the shift register 40. As a result, the FPGA data module 2-1 is shifted to the data register 41a. At the same time, the controller 47 controls the parameters in the parameter register 45 to be written into one part of the flip flop 43b, and controls the parameters in the parameter buffer 46 to be written into the other part of the flip flop 43b.

The logic block 43 reconfigures the logic circuit by referring to the data register 41a which stores the FPGA data module 2-1 which has been shifted thereto. The gate circuit 43a and the flip flop 43b executes the logical function for logic input data by referring to the data register 41a which stores the FPGA data module 2-1 as a LUT. Thus, the computing system 101 can execute an operation corresponding to the FPGA data module 2-1 as the main routine again.

The FPGA data module 2-n as the subroutine may further call another data module except the FPGA data module 2-1. In this case, when an operation corresponding to the FPGA data module 2-n is completed, the parameters stored in the parameter register 45 are pushed down. The flip flop 43b stores internal parameters as results of the operation corresponding to the FPGA data module 2-n. All or part of the internal parameters stored in the flip flop 43b are transferred onto the very top of the parameter register 45 along with a routine identifier. Together with a parameter stored at the top of the parameter register 45, the routine identifier designates the FPGA data module 2-n to be called back. When the FPGA data module 2-n is called back in accordance with this routine identifier, the internal parameter stored at the top of the parameter register 45 is written into all or a part of the flip flop 43b. Other parts of this calling process are same as the process where the FPGA data module 2-n is called by the FPGA data module 2-1. The calling-back process is the same as the process where the FPGA data module 2-1 is called back by the FPGA data module 2-n.

At least one of the FPGA data modules 2-1 to 2-n may be one that is suited to a recursive program. A recursive program is a program which calls itself during execution thereof.

As described above, parameters stored in the flip flop 43b as internal parameters of the logic block 43 are stored in the parameter register 45 for stacking. After stacking the internal parameters, a data module called as a subroutine is transferred to the data register 41a. The data register 41a which stores one of the FPGA data modules 2-1 to 2-n can be referred to as a LUT by the logic block 43. When a data module as a main routine is called back, the parameters stored in the parameter register 45 are restored in the logic block 43. In this way, a large-sized program comprising a plurality of modules can be executed by hardware. Time required for executing a program by hardware is shorter than time required for executing a program by software using a CPU. The computing system 101 can execute logic computing at high speed.

While the data register 41a which stores one of the FPGA data modules 2-1 to 2-n is referred to by the logic block 43, the loader 3 can load another one of the FPGA data modules 2-1 to 2-n from the FPGA data storage 2 to one of the data registers 41b to 41d. By this loading, another one of the FPGA data modules 2-1 to 2-n may be written sequentially into one of the data registers 41b to 41d. The shift register 40 shifts data modules stored in the data registers 41a to 41d in parallel. Time required for shifting data modules is much shorter than time required for writing data modules. Accordingly, overhead incurred in the FPGA device 4 by updating configuration data is much smaller than overhead incurred in a structure having only one configuration memory.

The FPGA data modules 2-1 to 2-n are generated so as to correspond to the source programs 5-1 to 5-n by compiling by the compiler 6. The source programs 5-1 to 5-n are divided by module units. Therefore, the source programs 5-1 to 5-n can be created independently from one another. In addition, each of the source programs 5-1 to 5-n can be reused as a part of another software.

Internal parameters of the logic block 43 stored in the flip flop 43b are stored in the parameter register 45 and/or the parameter buffer 46 when a LUT (a data module stored in the data register 41a) is changed to another one. The parameter register 45 stores internal parameters for stacking, and the parameter buffer 46 stores internal parameters for handing. Parameters stored in the parameter buffer 46 are handed from a main routine process to a subroutine process, or from a subroutine process to a main routine process. Parameters stored in the parameter register 45 are restored when processing returns to a main routine from a subroutine. A large-sized program including a lot of modules can be executed by hardware due to this structure.

Various modifications and applications are available with respect to the computing system 101 according to the first embodiment.

In one example, a data module registered in arbitrary one of the data registers 41a to 41d may be read out so as to be referred to as a LUT by the logic block 43. In this example, the data registers 41a to 41d of the shift register 40 are connected to read enable lines. One of the FPGA data modules 2-1 to 2-n that is registered in one of the data registers 41a to 41d can be read out in accordance with one of the read enable lines that is at an active level.

In another example, a plurality of data modules stored in the shift register 40 may be read out at a same time. In this example, two or more of the FPGA data modules 2-1 to 2-n that are stored in two or more of the data registers 41a to 41d can be read out at a same time in accordance with two or more of read enable lines that are at an active level. The logical function of the gate circuit 43a is determined based on the data modules that are read out from the shift register 40.

Further, the loader 3 may load a data module from the FPGA data storage 2 to only one of the data registers 41a to 41d (for example, only the data register 41d).

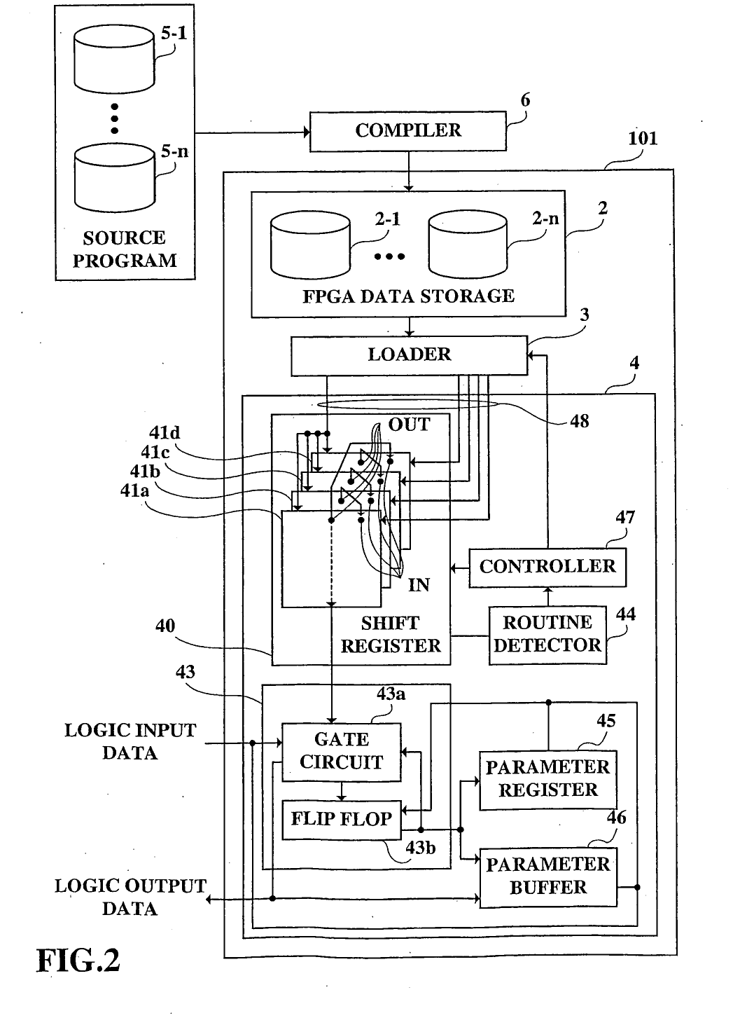

In a case where each of the data registers 41b to 41d is a dual port RAM, an output port of one of the data registers 41a to 41d may be connected to an input port of another one of the data registers 41a to 41d. For example, in the shift register 40 shown in FIG. 2, the output port (OUT) of the data register 41d is connected to the input port (IN) of the data register 41c. The output port of the data register 41c is connected to the input port of the data register 41b. The output port of the data register 41b is connected to the input port of the data register 41a. The output port of the data register 41a is connected to the input port of the data register 41d. In this structure, data modules stored in the data registers 41a to 41d are transferred among the data registers 41a to 41d circularly.

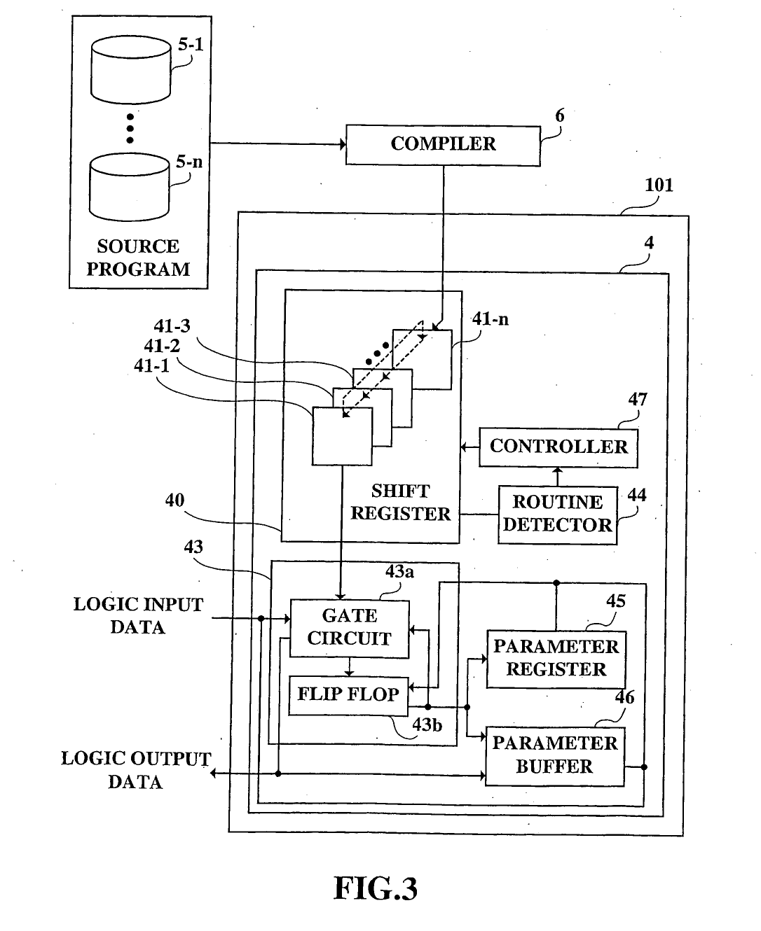

As shown in FIG. 3, the shift register 40 may comprise data registers 41-1 to 41-n in accordance with the FPGA data modules 2-1 to 2-n. The number of FPGA data modules 2-1 to 2-n and the number of data registers 41-1 to 41-n are the same. In this structure, the compiler 6 stores one of the source programs 5-1 to 5-n which has been compiled in the data register 41-n. The shift register 40 shifts data stored in the data registers 41-1 to 41-n once, each time the compiler 6 compiles one of the source programs 5-1 to 5-n. When the compiler 6 completes compiling of all of the source programs 5-1 to 5-n, the shift register 40 retains all of the FPGA data modules 2-1 to 2-n in the data registers 41 -1 to 41-n. The shift register 40 shifts one of the FPGA data modules 2-1 to 2-n to the data register 41-1 as the processing of the program proceeds. The data module shifted to the data register 41-1 is referred to as a LUT by the logic block 43. In other words, the shift register 40 shown in FIG. 3 enables a LUT to be replaced with another one without loading the FPGA data modules 2-1 to 2-n.

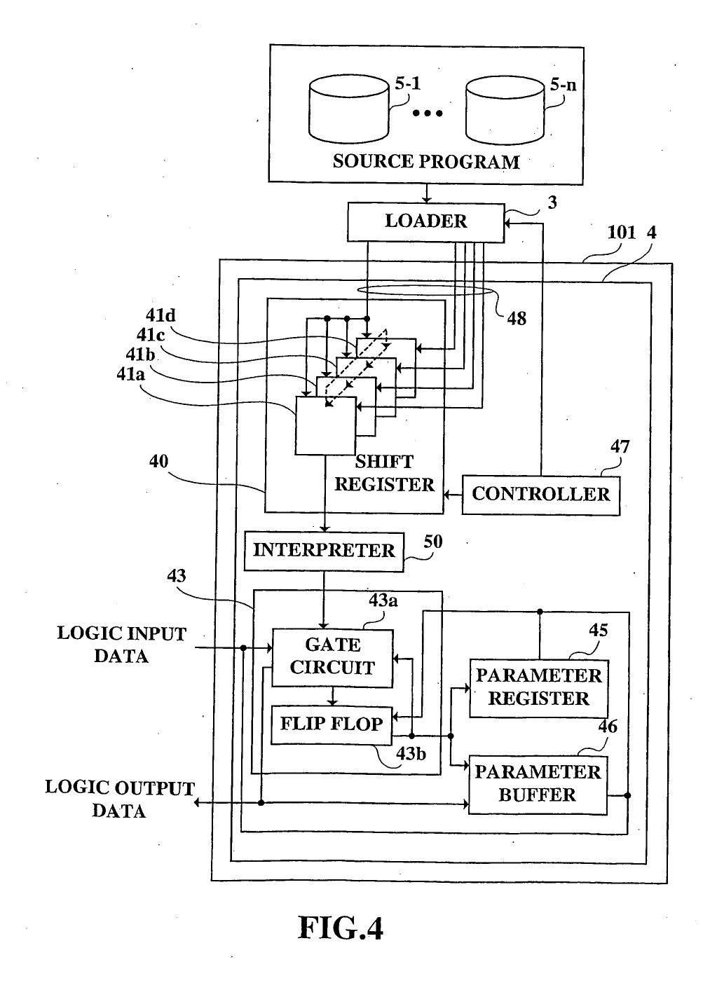

The source programs 5-1 to 5-n may be loaded to the data registers 41a to 41d directly without the compiler 6. In this case, as shown in FIG. 4, the FPGA device 4 comprises an interpreter 50 which is connected between the shift register 40 and the logic block 43. For example, the interpreter 50 is realized by hardware including a combination of a plurality of gate circuits. The logic block 43 can reconfigure the logic circuit based on an output from the interpreter 50 with causing almost no influence on the execution speed of computing. An output of the data circuit 43a is acquired into all or a part of the flip flop 43b, each time execution of an operation included in the source programs is completed. Thus, operations included in the source programs are executed one after another.

According to this structure, the shift register 40 supplies one of the source programs 5-1 5 to 5-n that is stored in the data register 41a to the interpreter 50.

The interpreter 50 interprets operation codes included in the source program stored in the data register 41a one by one. The logical function of the gate circuit 43a is determined based on the result of interpreting by the interpreter 50. If another source program is called as a result of interpreting, the controller 47 detects this call. Under the control of the controller 47, one of the source programs 5-1 to 5-n is loaded, and/or the shift register 40 is driven, in order that the called source program may be stored in the data register 41a. When detecting a call of a source program, the controller 47 stores internal parameters stored in the flip flop 43b, in the parameter register 45 and/or the parameter buffer 46. In addition, the controller 47 stores a main routine identifier in the parameter register 45 in association with the internal parameters.

When an operation corresponding to one of the source programs 5-1 to 5-n that is called as the subroutine is completed, another one of the source program 5-1 to 5-n is called back as the main routine. At this time, the controller 47 stores the logic output data of the logic block 43 in the parameter buffer 46. And the controller 47 obtains the main routine identifier stored in the parameter register 45. Based on this main routine identifier, the controller 47 drives the shift register 40. At the same time, the controller 47 controls the parameters stored in the parameter register 45 to be written into one part of the flip flop 43b, and controls the parameters stored in the parameter buffer 46 to be written into the other part of the flip flop 43b.

Thereby, the source programs 5-1 to 5-n can be loaded to one of the data registers 41a to 41d by module units. Due to this, a large-sized program made up of a plurality of modules can be executed by hardware without the compiler 6. Since the source programs 5-1 to 5-n can be shifted among the data registers 41a to 41d circularly, overhead incurred in the FPGA device 4 by updating the configuration data is much smaller than overhead incurred in a structure having only one configuration memory.

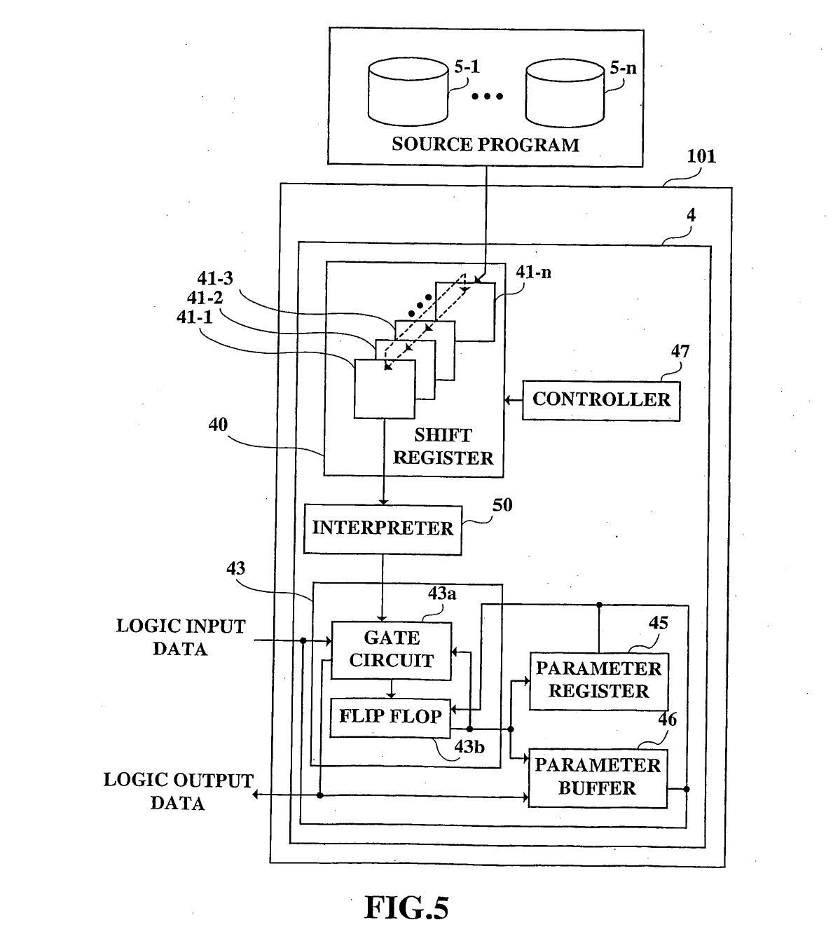

As shown in FIG. 5, the shift register 40 may comprise data registers 41-1 to 41-n in accordance with the source programs 5-1 to 5-n. The number of source programs 5-1 to 5-n and the number of data registers 41-1 to 41-n are the same. The shift register 40 stores all of the source programs 5-1 to 5-n in the data registers 41-1 to 41-n. The shift register 40 shifts one of the source programs 5-1 to 5-n to the data register 41-1 in accordance with the progress of the program. The source program shifted to the data register 41-1 is interpreted by the interpreter 50. In other words, the shift register 40 shown in FIG. 5 enables the source programs to be changed with the others without loading the source programs 5-1 to 5-n.

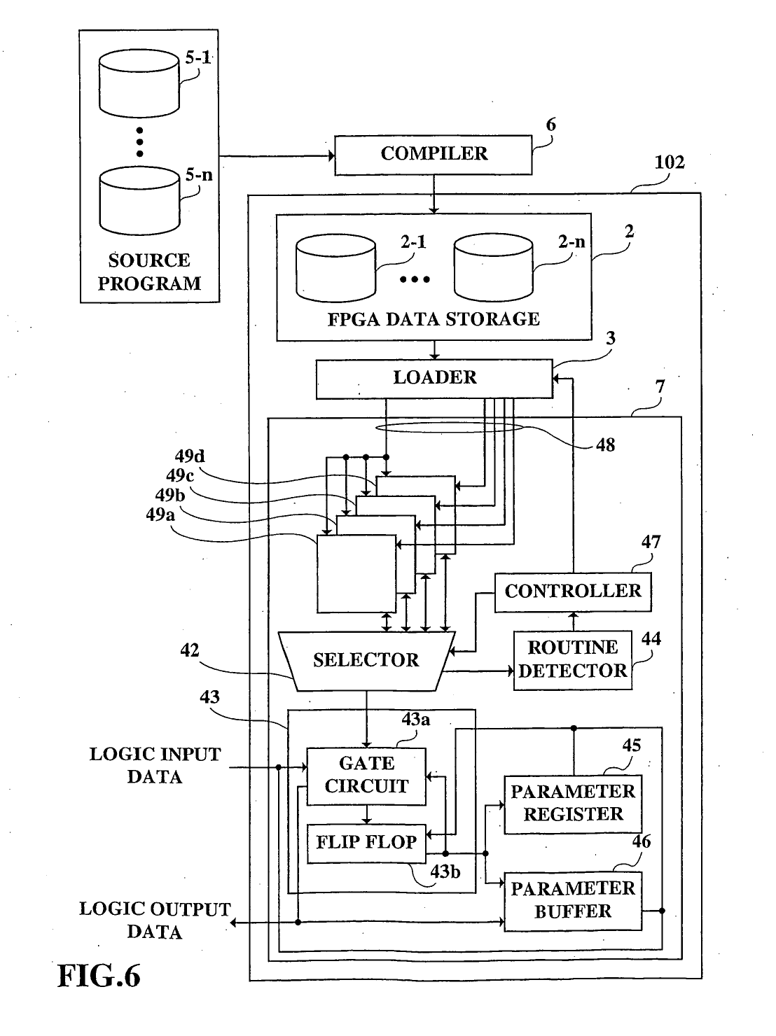

FIG. 6 shows a structure of a computing system 102 according to a second embodiment of the present invention. In FIG. 6, structures same as those of the computing system 101 according to the first embodiment are given same reference numerals. As shown in FIG. 6, a FPGA device 7 of the computing system 102 comprises a selector 42 and data memories 49a to 49d instead of the shift register 40.

The selector 42 selects one of the data memories 49a to 49d in accordance with a control signal received from the controller 47. A data module in the data memory selected by the selector 42 is referred to as a LUT by the logic block 43. For example, the selector 42 may be a multiplexer having four inputs and one output. Each of the four inputs of the selector 42 is respectively connected to one of a plurality of memory cells included in each of the data memories 49a to 49d. In the actual FPGA device 7, the number of selectors 42 may correspond to the size of a LUT. For exemplary explanation, FIG. 6 shows one selector 42. The data memory to be selected by the selector 42 may be changed with another one among the data memories 49a to 49d circularly. Further, the selector 42 may select two or more of the data memories 49a to 49d at a same time.

Each of the data memories 49a to 49d is a flip flop or a RAM, for example. As well as the data registers 41a to 41d of the first embodiment, each of the data memories 49a to 49d is connected to the loader 3 via the bus 48. The bus 48 includes a data bus, an address bus, a write enable line, and the like. When a signal on the write enable line of the bus 48 is active, data corresponding to a signal on the data bus of the bus 48 is written into address(s) corresponding to a signal on the address bus of the bus 48 in one or more of the data memories 49a to 49d. In a case where each of the data memories 49a to 49d is a RAM, each of the data memories 49a to 49d is connected to a read enable line. A signal of an active level is supplied to a read enable line which is connected to one of the data memories 49a to 49d selected by the selector 42. In a case where the selector 42 selects two or more of the data memories 49a to 49d at a same time, a signal of an active level may be supplied to a plurality of read enable lines connected to the plurality of data memories 49a to 49d. One of the data memories 49a to 49d which is selected by the selector 42 is referred to as a LUT by the logic block 43.

According to the computing system 102 of the second embodiment, one of the FPGA data modules 2-1 to 2-n is loaded by the loader 3 from the data storage 2 to the data memories 49a to 49d, likewise the first embodiment. For example, the FPGA data module 2-1 is loaded to the data memory 49a. The selector 42 selects one of the data memories 49a to 49d in accordance with a control signal supplied from the controller 47. In this example, the selector 42 selects the data memory 49a. The logic block 43 forms a logic circuit by referring to one of the data memories 49a to 49d selected by the selector 42, i.e., the data memory 49a. The gate circuit 43a and the flip flop 43b generates a logical function value of logic input data by referring to the data memory 49a as a LUT. The routine detector 44 detects a call by the data module stored in the data memory 49a selected by the selector 42, to another data module.

For example, the FPGA data module 2-1 is related to the FPGA data module 2-n. in this case, the routine detector 44 detects a call by the FPGA data module 2-1 to the FPGA data module 2-n. The controller 47 controls actions of the logic block 43, the parameter register 45, and the parameter buffer 46, likewise the first embodiment.

The controller 47 searches the data memories 49a to 49d for the FPGA data module 2-n as the subroutine. If the FPGA data module 2-n is not found, a load command is sent from the controller 47 to the loader 3. In this example, the FPGA data module 2-n is loaded from the FPGA data storage 2 to the data memory 49b in accordance with the load command. When loading of the FPGA data module 2-n is completed, the controller 47 sends a control signal for controlling the selector 42 to select the data memory 49b. In accordance with this control signal, the selector 42 selects the data memory 49b.

On the contrary, if the FPGA data module 2-n is found in any of the data memories 49a to 49d, the controller 47 sends a control signal to the selector 42 without loading any data module.

The logic block 43 reconfigures the logic circuit by referring to the data memory 49b selected by the selector 42. When reconfiguration of the logic circuit is completed, the gate circuit 43a and the flip flop 43b can generate a logical function value of logic input data by referring to the data memory 49b storing the FPGA data module 2-n as a LUT.

When an operation corresponding to the FPGA data module 2-n is completed, the controller 47 sends a control signal for selecting the data memory 49a to the selector 42, in order to call back the FPGA data module 2-1 as the main routine. In accordance with this control signal, the selector 42 selects the data memory 49a.

The logic block 43 reconfigures the logic circuit by referring to the data register 41a storing the shifted FPGA data module 2-1. The gate circuit 43a and the flip flop 43b executes the logical function for the logic input data by referring to the data register 41 storing the FPGA data module 2-1 as a LUT. Thus, the computing system 102 can execute an operation corresponding to the FPGA data module 2-1 as the main routine again.

Likewise the first embodiment, the FPGA data module 2-n as the subroutine may further call another data module except the FPGA data module 2-1.

According to this structure, a large-sized program comprising a plurality of modules can be executed by hardware. Logic computing by the computing system 102 can be executed at higher speed than logic computing by software using a CPU. While one of the data memories 49a to 49d selected by the selector 42 is referred to by the logic block 43, the loader 3 can rewrite another one of the data memories 49a to 49d in order to load one of the FPGA data modules 2-1 to 2-n. The LUT is changed with another one instantly by changing selection by the selector 42. Accordingly, overhead incurred in the FPGA device 7 by updating the configuration data is much smaller than overhead incurred in a structure having only one configuration memory.

Various modifications and applications are available with respect to the computing system 102 according to the second embodiment.

For example, the selector 42 may select the data memories 49a to 49d circularly. More specifically, after selecting the data memory 49a, the selector 42 selects the data memory 49b. After selecting the data memory 49b, the selector 42 selects the data memory 49c. After selecting the data memory 49c, the selector 42 selects the data memory 49d. After selecting the data memory 49d, the selector 42 selects the data memory 49a. In this action, the selector 42 and the data memories 49a to 49d realize substantially the same function as that of the shift register 40 of the first embodiment.

The FPGA device 7 may comprise n number of data memories in accordance with the FPGA data modules 2-1 to 2-n, based on the same idea as that of the computing system 101 shown in FIG. 3. In this case, the selector 42 may be a multiplexer having n number of inputs and one output.

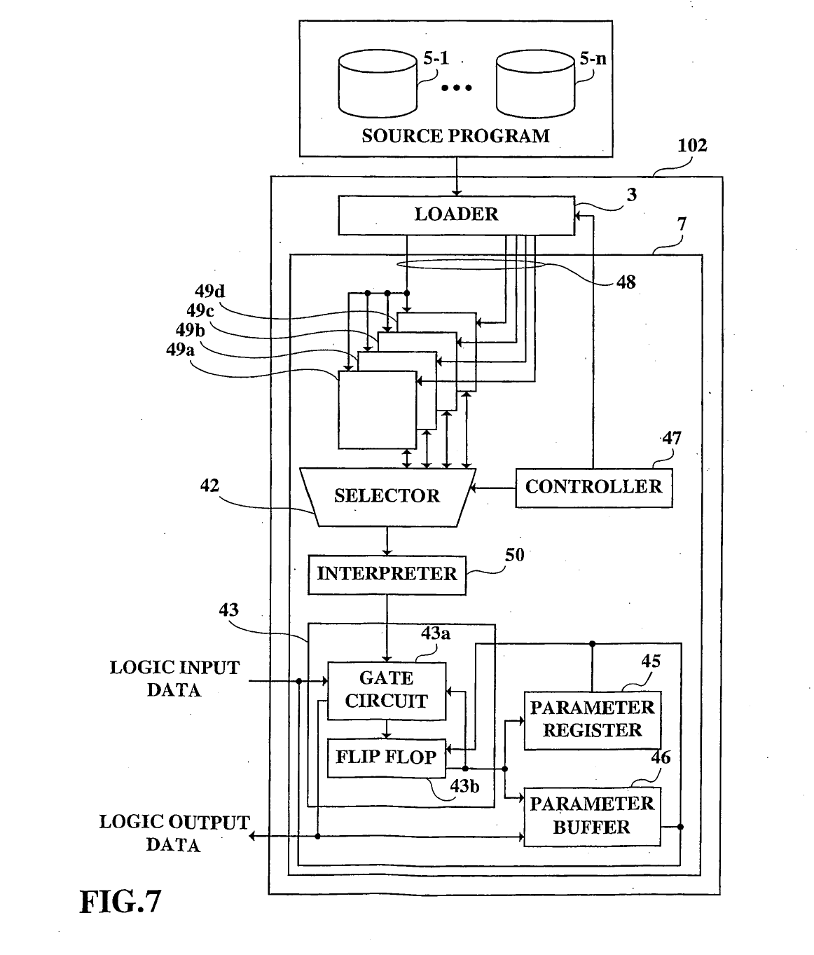

The source programs 5-1 to 5-n may be loaded to the data memories 49a to 49d directly without the compiler 6. In this case, as shown in FIG. 7, the FPGA device 7 comprises an interpreter 50 which is connected between the selector 42 and the logic block 43. The interpreter 50 interprets one operation code after another which are included in the source program which is stored in one of the data memories 49a to 49d selected by the selector 42. The FPGA device 7 may comprise n number of data memories in accordance with the source programs 5-1 to 5-n, based on the same idea as that of the computing system 101 shown in FIG. 5.

This application is based on Japanese Patent Application No. 2001-401462 filed on Dec. 28, 2001 and including specification, claims, drawings and summary. The disclosure of the above Japanese Patent Application is incorporated herein by reference in its entirety.

### INDUSTRIAL APPLICABILITY

The present invention relates to direct execution of a large-sized program including a plurality of modules by hardware, without using a general-purpose CPU.

1. A logic computing system comprising:
a plurality of data storage units (41a to 41d, 49a to 49d) which store a plurality of configuration data modules each of which includes a look up table; and
a logic computing unit (43) which includes a plurality of programmable logic circuits (43a),
wherein said logic computing unit provides a logical function value of logic input data as logic output data, by referring to at least one configuration data module stored in at least one of said plurality of data storage units (41a to 41d, 49a to 49d).

2. The logic computing system according to claim 1, wherein:
said plurality of data storage units (41a to 41d) form a shift register (40); and
said logic computing unit (43) refers to the configuration data module(s) stored in one or more of said plurality of data storage units (41a to 41d) included in said shift register (40).

3. The logic computing system according to claim 2,
wherein said shift register shifts (40) the configuration data modules among said plurality of data storage units (41a to 41d) circularly.

4. The logic computing system according to claim 1, comprising a selector (42) which selects at least one of said plurality of data storage units (49a to 49d),
wherein said logic computing unit (43) refers to the configuration data module which is stored in said data storage unit selected by said selector (42).

5. The logic computing system according to claim 4,
wherein said selector selects one of said plurality of data storage units (49a to 49d) from among said plurality of data storage units circularly.

6. The logic computing system according to claim 1, comprising:
a parameter register (45) which stores all or part of internal parameters of said logic computing unit (43) for stacking;
a detector (44) which detects a call and a call back by one of the plurality of configuration data modules to another one of the plurality of configuration data modules; and
a controller (47) which controls logic computing by said logic computing unit,
wherein said controller (47):
stores the internal parameters of said logic computing unit in said parameter register (45), when said detector (44) detects a call by one of the plurality of configuration data modules to another one of the plurality of configuration data modules as a subroutine; and
restores the internal parameters stored in said parameter register (45) in said logic computing unit (43), when said detector (44) detects a call back to one of the plurality of configuration data modules.

7. The logic computing system according to claim 1, further comprising a loader (3) which loads the configuration data module(s) to one or more of said plurality of data storage units (41a to 41d, 49a to 49d),
wherein each of said plurality of data storage units (41a to 41d, 49a to 49d) stores the configuration data module rewritably.

8. The logic computing system according to claim 7, comprising:
a detector (44) which detects a call by one of the plurality of configuration data modules to another one of the plurality of configuration data modules; and
a controller (47) which controls logic computing by said logic computing unit (43),
wherein
said controller (47):
searches, when said detector (44) detects a call by one of the plurality of configuration data modules to another one of the plurality of configuration data modules as a subroutine, said plurality of data storage units (41a to 41d, 49a to 49d) for the configuration data module as the subroutine; and
sends a load command to said loader (3), in a case where the configuration data module as the subroutine is not searched out, and
said loader (3) loads the configuration data module as the subroutine which is indicated by the load command to one of said plurality of data storage units (41a to 41d, 49a to 49d).

9. The logic computing system according to claim 1, comprising:
a parameter buffer (46) which stores all or part of internal parameters of said logic computing unit (43) for handing;
a detector (44) which detects a call or a call back by one of the plurality of configuration data modules to another one of the plurality of configuration data modules; and
a controller (47) which controls logic computing by said logic computing unit,
wherein said controller (47):
stores the internal parameters of said logic computing unit (43) in said parameter buffer (46), when said detector (44) detects a call or a call back by one of the plurality of configuration data modules to another one of the plurality of configuration data modules; and
inputs the parameters stored in said parameter buffer (46) to said logic computing unit (43), when the configuration data module which is called or called back is arranged so that it can be referred to by said logic computing unit (43).

10. The logic computing system according to claim 1, comprising a compiler (6) which creates each of the plurality of configuration data modules based on each of a plurality of source program modules.

11. A logic computing method comprising:
storing a plurality of configuration data modules each of which includes a look up table in a plurality of data storage units (41a to 41d, 49a to 49d);
preparing a logic computing unit (43) which includes a plurality of programmable logic circuits (43a);
referring by said logic computing unit (43) to at least one configuration data module stored in at least one of the plurality of data storage units (41a to 41d, 49a to 49d); and
providing a logical function value of logic input data as logic output data, based on the configuration data module referred to by said logic computing unit (43).

12. The logic computing method according to claim 11, comprising:
forming a shift register (40) using said plurality of data storage units (41a to 41d); and
referring to the configuration data module(s) stored in at least one or more of said plurality of data storage units (41a to 41d) included in said shift register (40).

13. The logic computing method according to claim 12, comprising shifting by said shift register (40) the configuration data modules among said plurality of data storage units (41a to 41d) circularly.

14. The logic computing method according to claim 11, comprising:
selecting by a selector (42) at least one of said plurality of data storage units (49a to 49d); and
referring to the configuration data module stored in said data storage unit selected by said selector (42).

15. The logic computing method according to claim 14,
wherein selection made by said selector (42) is changed among said plurality of data storage units (49a to 49d) circularly.

16. The logic computing method according to claim 11, comprising:
detecting a call by one of the plurality of configuration data modules to another one of the plurality of configuration data modules as a subroutine;
storing all or part of internal parameters of said logic computing unit (43) in a parameter register (45) in response to said detecting; and
restoring the internal parameters stored in said parameter register (45) in said logic computing unit (43), when one of the plurality of configuration data modules is called back.

17. The logic computing method according to claim 11, comprising:
storing the plurality of configuration data modules in said plurality of data storage units (41a to 41d, 49a to 49d) rewritably; and
loading by a loader (3) at least one of the plurality of configuration data modules to be stored in said plurality of data storage units (41a to 41d, 49a to 49d).

18. The logic computing method according to claim 17, comprising:
searching, when a call by one of the plurality of configuration data modules to another one of the plurality of configuration data modules as a subroutine is detected, said plurality of data storage units (41a to 41d, 49a to 49d) for the configuration data module as the subroutine;
sending a load command to said loader (3), in a case where the configuration data module as the subroutine is not searched out; and
loading by said loader (3) the configuration data module as the subroutine which is indicated by the load command to one of said plurality of data storage units (41a to 41d, 49a to 49d).

19. The logic computing method according to claim 11, comprising:
detecting a call or a call back by one of the plurality of configuration data modules to another one of the plurality of configuration data modules;
storing all or part of internal parameters of said logic computing unit (43) in a parameter buffer (46) in response to said detecting; and
inputting the parameters stored in said parameter buffer (46) to said logic computing unit (43), when the configuration data module which is called or called back is arranged so that it can be referred to by said logic computing unit (43).

20. The logic computing method according to claim 11, comprising creating by a compiler (6) each of the plurality of configuration data modules based on each of a plurality of source program modules.
